(19) United States
(12) Patent Application Publication
(10) Pub. No.: US 2020/0099644 A1
(43) Pub. Date: Mar. 26, 2020

(54) COMMUNICATION SYSTEM BETWEEN CONTROL CENTER AND PLURALITY OF MOBILE USERS

(71) Applicant: PMB TECNO SRL, Osimo (IT)

(72) Inventor: Enrico Bastianelli, Osimo (IT)

(21) Appl. No.: 16/137,884

(22) Filed: Sep. 21, 2018

(51) Int. Cl. H04L 12/58

(52) U.S. Cl. CPC H04L 51/22; H04L 51/38

(57) ABSTRACT

A system for communicating between a control center and multiple mobile users comprises a server corresponding to the control center, and portable devices corresponding to the mobile users. The devices are wirelessly communicated with the server. One aspect of the invention features a server database comprising mailboxes respectively associated with the devices. The server is configured to post messages to a respective mailbox for subsequent retrieval by the associated device. Each device is configured for monitoring its associated mailbox to check for messages. Each portable device is configured to retrieve an unread message upon detection thereof. Another aspect of the invention features the devices being configured to receive as input an identity of an assigned mobile user, who is temporarily assigned to operate the portable device for a period of time, and to incorporate as part of an outgoing message an identifier indicating the identity of the assigned mobile user.

### FIELD OF THE INVENTION

The present invention relates generally to a communication system between a control center and a plurality of mobile users, and more particularly to such a communication system in which retrieval of user-specific messages is performed without manual monitoring by the user and in which identities of mobile users temporarily operating the portable devices to send messages therefrom can be tracked.

### BACKGROUND

In large industry-dedicated communication systems comprising a centralized control center and a plurality of mobile users, such as in emergency service dispatch where there is a centralized dispatch center for a region and a plurality of emergency responders who are remote from the dispatch center performing their duties, there are challenges in communicating information between the control center and specific remote entities on such a large network.

### SUMMARY OF THE INVENTION

According to an aspect of the invention there is provided a system for communicating between a control center and a plurality of mobile users, comprising:

a server including a memory storing instructions and a processor configured to execute the instructions stored on the memory;

a plurality of portable devices corresponding to the mobile users that are wirelessly communicated with the server;

the memory of the server storing a database which comprises a plurality of mailboxes each associated with a respective one of the portable devices;

the server being configured to post messages to a respective one of the mailboxes for subsequent retrieval by the associated one of the portable devices;

each one of the portable devices being configured for monitoring an associated one of the mailboxes on the database to check for messages which are unread; and

each one of the portable devices being further configured to retrieve a respective one of the messages which are unread upon detection thereof during monitoring the associated one of the mailboxes.

In this arrangement the user is enabled to perform other activities while the device by which the user remains in communication with the control center automatically retrieves communications therefrom that are intended for that user.

In the illustrated arrangement, each one of the portable devices is configured for monitoring by periodic scanning of the associated one of the mailboxes after a prescribed period of time has elapsed since a latest mailbox scan.

In the illustrated arrangement, each one of the portable devices is configured to download to a memory thereof the respective one of the messages retrieved from the associated one of the mailboxes.

In the illustrated arrangement, the portable devices are registered on the server so as to form the mailboxes stored on the database of the server.

In the illustrated arrangement, the server is configured to form the messages each having a message body with instructions for a respective one of the mobile users operating said respective one of the portable devices, and an error detection code which is checked by the respective one of the portable devices upon retrieval of the respective one of the messages to ensure said respective one of the messages has not been corrupted during wireless transmission.

In the illustrated arrangement, each one of the portable devices is configured to automatically execute the instructions of the message body on a processor of the respective one of the portable devices if the respective one of the messages is determined not to have been corrupted.

In one example, the instructions comprise directions to a destination location which are loaded by the processor of the respective one of the portable devices onto a navigation application stored on a memory of the respective one of the portable devices.

According to another aspect of the invention there is provided a system for communicating between a control center and a plurality of temporary mobile users, comprising:

a server including a memory storing instructions and a processor configured to execute the instructions stored on the memory;

a plurality of portable devices wirelessly communicated with the server that are temporarily assigned to the mobile users for use thereby such that different ones of the mobile users can use a respective one of the portable devices at different times;

each one of the portable devices being configured to generate a message receivable by the server;

each one of the portable devices being configured to receive as input an identity of an assigned one of the mobile users operating the respective one of the portable devices for a period of time;

each one of the portable devices being configured to incorporate as part of the message a user identifier indicating the identity of the assigned one of the mobile users sending the message to the server.

Thus the system is enabled to keep track of the various users who are not tied to operating specific devices. For example, in a service industry a company deploys a limited number of devices which are shared by employees. Thus, for example, different employees working different shifts act to share a common one of the devices.

In the illustrated arrangement, the server is configured to form a record of messages sent by the portable devices categorized by the assigned one of the mobile users.

In the illustrated arrangement, each one of the portable devices is configured to automatically incorporate the user identifier for each message sent subsequently to a latest input identity of the assigned one of the mobile users.

### BRIEF DESCRIPTION OF THE DRAWINGS

The invention will now be described in conjunction with the accompanying drawings in which:

FIG. 1 is a schematic illustration showing, in general, an arrangement of system for communicating between a control center and a plurality of mobile users according to the present invention;

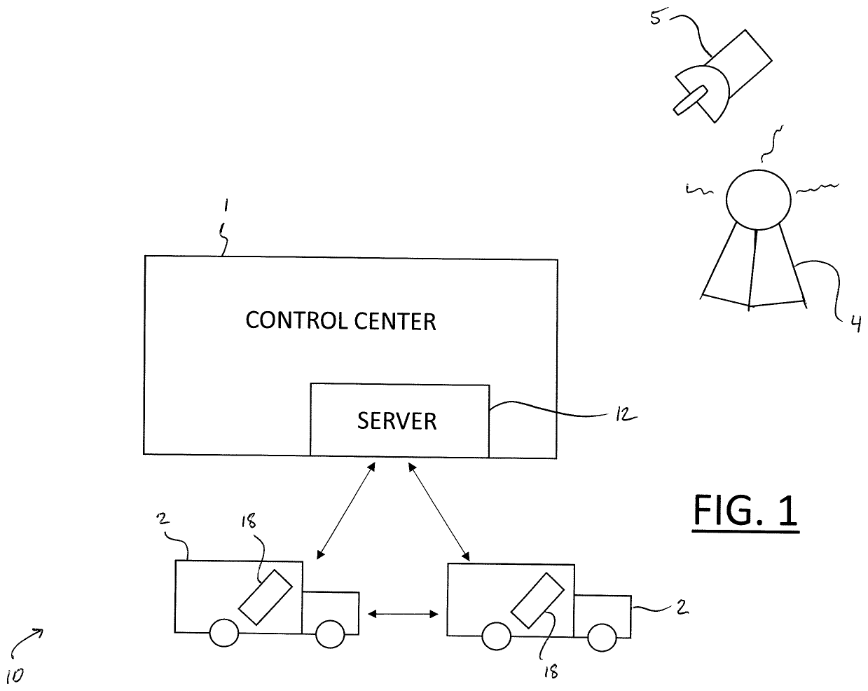

FIG. 2 is a schematic illustration of a server and portable devices wirelessly communicated with the server of the arrangement of FIG. 1;

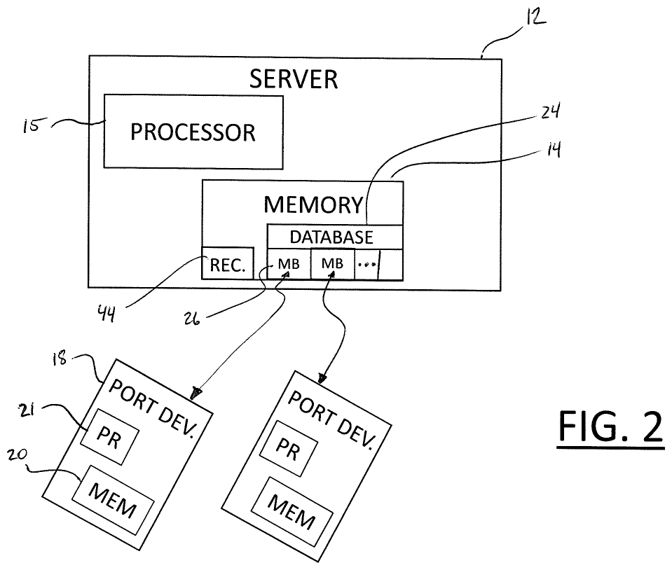

FIG. 3 is a schematic illustration of a message generated by the server for retrieval by the portable devices; and

FIG. 4 is a schematic illustration of a message generated by a portable device to be received by the server.

In the drawings like characters of reference indicate corresponding parts in the different figures.

### DETAILED DESCRIPTION

In the accompanying figures there is shown a system 10 for communicating between a control center 1 and a plurality of mobile users 2. It is contemplated that one example application of the system 10 is emergency service dispatch in which a centralized dispatch center receiving instructions to coordinate healthcare-related activities then communicates instructions to a plurality of emergency responders who carry out the activities remote from the dispatch center. However, it will be appreciated that this is simply one example of a plurality of various possible applications of the system 10 described herein.

In such contexts, managing communications between the single control center 1 and targeted ones of the mobiles users 2 being directed thereby is among the most challenging aspects of operating such a communications system.

There thus is provided at the control center 1 a server computer 12 which includes a memory 14 operably coupled to a processor 15 which is configured to execute instructions stored on the server memory 14.

The server 12 is wirelessly communicated with a plurality of portable devices 18 which respectively also include a memory 20 operably coupled to a processor 21 which is configured to execute instructions stored on the device memory 20. The portable devices 18 are also wirelessly communicated with one another.

In the example of emergency service dispatch, the portable devices 18 are associated with assigned emergency response vehicles, such as ambulances, which are used by a team of emergency responders.

The portable devices 18 are small in size with a built-in 5 or 10 inch screen (not shown) and are configured to use terrestrial communication, for example antennas 4, and satellite communication as schematically indicated by satellite 5. The switch between terrestrial and satellite communications can be done automatically or manually, but irrespective thereof switching from one to the other is immediate. The integration between terrestrial and satellite communication modules can take place in two ways:

1. The two modules are physically integrated into the same electrical circuit together with the switching managing circuit.

2. The two modules are wirelessly connected (Bluetooth, Wi-Fi, NFC, etc.) to a third circuit that manages the switching.

In either one of the above example cases, the circuit which manages switching, through hardware and software controls, measures the power of the signal coming from the terrestrial network 4. As long as the signal is stronger than a predetermined threshold which can be adjusted, communication is usually done via terrestrial network 4. As soon as the signal level falls below the threshold, the circuit automatically switches-off the terrestrial transceiver and switch-on the satellite transceiver to communicate with the satellite network 5.

Alternatively, in the arrangement of a circuit with a manual switch in the portable device 18, a dedicated key on the device 18 performs the sequential operations described above and allows for manual switching between the terrestrial and satellite communication module.

To facilitate the communication between the control center 1 and portable devices 18, the memory 14 of the server 12 stores a database 24 which comprises a plurality of mailboxes 26 each associated with a respective one of the portable devices 18. The portable devices 18 are registered on the server 12 so as to form the mailboxes 26 stored on the database 24 of the server 12. The server 12 is configured to post messages 29 to a respective one of the mailboxes 26 for subsequent retrieval by the associated one of the portable devices 18.

Each one of the portable devices 18 is configured for monitoring an associated one of the mailboxes 26 on the server database 24 to check for messages 29 which are unread. The monitoring comprises periodic scanning of the associated mailbox 26 by the corresponding portable device 18 after a prescribed period of time has elapsed since a latest mailbox scan. For example, the prescribed period of time may be one second such that at regular intervals of one second the portable device 18 checks its associated mailbox 26.

Each portable device 18 is further configured to retrieve unread messages 29 upon detection thereof during monitoring of the portable device's associated mailbox 26. Each portable device 18 is configured to download the retrieved message 29 to its device memory 20.

As such, the user is enabled to perform other activities while the device 18 by which the user remains in communication with the control center 1 automatically retrieves communications therefrom that are intended for that user.

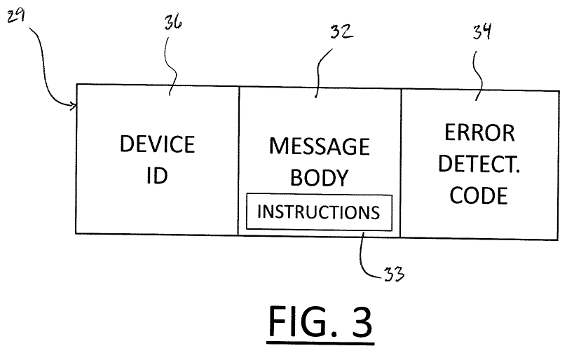

Referring to FIG. 3, each message 29 formed by the server 12 comprises a message body 32 with instructions 33 for the intended recipient who is a respective mobile user operating the respective portable device 18. The message 29 also includes an error detection code 34 which is checked by the receiving portable device 18 upon retrieval of that message to ensure the message has not been corrupted during wireless transmission. The message 29 additionally includes a device identifier 36 which allows the server 12 to correctly post the message 29 to the mailbox 26 of the intended recipient device 18.

Initially, upon retrieval of the message 29 by the portable device 18, the device 18 is configured to check the error detection code 34. If processing of the error detection code 34 indicates that the message 29 contains an error, which means that it has been corrupted during transmission, the device 18 dumps the retrieved message 29 and retrieves the same message 29 from the associated mailbox 26 until the processing of the error detection code indicates there is no error. As such, if the processing of the error detection code 34 indicates there is no error, the device 18 issues a confirmation of successful transmission of the message 29.

If the retrieved message 29 is determined not to have been corrupted, then the portable device 18 is configured to automatically execute the instructions 33 of the message body 32 on its processor 21. In one example, the message instructions 33 comprise directions to a destination location which are loaded by the device processor 21 onto a navigation application stored on the device memory 20 of the respective one of the portable devices. The message instructions 33 may be different in order to facilitate other functions for which the system 10 is configured to perform other functions, such as exchanging patient information between ambulances (corresponding to the users 2) and control center 1, identification of the location of all resources (i.e., users 2) in a territory or region of the control center 1, managing the meeting of a subset of the users 2 to facilitate the exchange of items or patients (which may alternatively be termed rendezvous), and measuring parametric patient data.

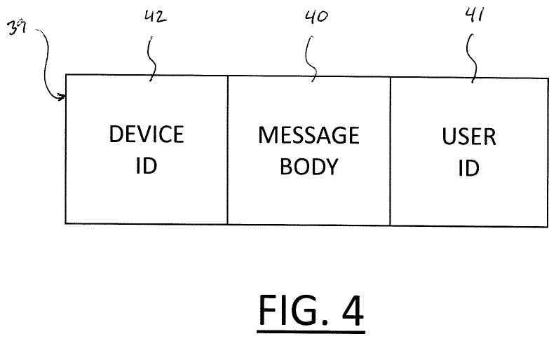

In addition to receiving messages 29 from the control center server 12, each portable device 18 is configured to generate a device message 39 which is receivable by the server 12 that is schematically shown in FIG. 4. Thus, the system 10 provides for communication in both directions between the control center 1 and the mobile users 2.

It will be appreciated that in many such applications as those for which the system 10 is suited for use, the portable devices 18 are temporarily assigned to the mobile users 2 for use thereby. Thus, over a period of time, different mobile users can use the same portable device but at different times, that is different windows of time, over that larger overall time period.

As such, each portable device 18 is configured to receive as input an identity of an assigned mobile user who is operating that portable device for a period of time. Each portable device 18 is further configured to incorporate as part of the device message 39, which comprises a message body 40 with instructions or communications to be processed at the server 12, a user identifier 41 which indicates the identity of the assigned mobile user who is sending the message 39 to the server 12, and a device identifier 42 indicating the device 18 sending the message. Each portable device 18 is configured to automatically incorporate the user identifier 41 for each message 39 sent subsequently to a latest input identity of the assigned mobile user. Thus, whenever the mobile user of a specific device changes, once the newly assigned user operating that portable device inputs his/her identity, the user identifier 41 of any subsequently sent messages from that device 18 will indicate that newly assigned user and not the previous user, which effectively has been overwritten by input of the new user.

As the portable devices 18 include the user identifier 41 to distinguish one assigned user from the other, the server 12 is configured to form a record 44 of messages 39 sent by all portable devices 18, which record 44 is categorized by the assigned mobile users, that is, based on the user identifiers 41. The message record 44 is stored on the memory 14 of the server 12 from which the information can be retrieved or accessed at a later time.

Generally speaking, the communication system 10 is able to facilitate the following functions, some of which are termed with particular consideration for the emergency dispatch-first responder example used herein:

Identification of locations of all users (with respect to the first responder example, referred to hereinafter as the “GPS positions of all means” function);

Navigation to destination (with respect to the first responder example, referred to hereinafter as the “Find Patient” function, which may provide an immediate automatic navigation to the patient);

Meeting between multiple users (with respect to the first responder example, referred to hereinafter as the “Rendezvous” function, which may provide an automatic management mechanism for rendezvous between two or more ambulances);

Local data acquisition, with forwarding to other users (with respect to the first responder example, referred to hereinafter as the “Health Monitoring system: a system for measuring and sharing parametric data of the patient” function);

Data/information forwarding to control center (with respect to the first responder example, referred to hereinafter as the “Patient Info” function, which may provide a Patient Information Exchange System between the ambulance and the operating center that allows pictures and video sending to represent the state of the patient through an automatic connection with the hospital servers to download the patient's pre-existing information);

User status inquiry (with respect to the first responder example, referred to hereinafter as the “Ambulance status management” function, which may provide ability to see if the ambulance is free or busy, and if it is busy what it is doing)

Updating activity log (with respect to the first responder example, referred to hereinafter as the “Health Card Compilation” function, which may provide creation/compilation of a health card as soon as the surgery is completed); and

User identification and management (with respect to the first responder example, referred to hereinafter as the “Management of the ambulance board crew” function”.

More specifically, in regard to the “GPS locations of all means” function, each portable device 18 is equipped with a localization system that can be GPS, GLONASS, GALILEO, earth-based triangulation systems for GSM/3G/4G-LTE terrestrial or localization systems by triangulation radio signals. The device message 39 containing the location information in the message body 40 is sent to the central server 12 and displayed on the screen located in the control center via a configurable dedicated mapping application. Sending a message containing location information can be done in 3 ways:

1. The device 18 sets a time interval in seconds, minutes or hours. An internal clock initially specially calibrated is dedicated to measuring the time elapsed. As soon as the time variable reaches the set interval, the message 39 containing the current position (in the message body 40) is sent.

2. Using the portable device 18, you set a maximum range in meters or miles. A specially calibrated software hardware system (on the portable device 18) is dedicated to measuring and calculating displacement by continuous and constant monitoring of the localization signal. As soon as the calculated displacement equals and/or exceeds the set value, the message 39 containing the actual position is sent.

3. The position data can be requested from the operating control center 1 at each device. This can be done in two modes:
Automatic: If the control center 1 has not received the position of a particular device 18 for a time longer than a preset threshold, then the server 12 automatically requests it by sending a specific signal as in the form of a message 29. The device 18 receiving the specific signal responds with its current position, which is then received by the server 12 application and displayed on cartography;
Manual: The operator at the control center 1 can select a specific device 18 and manually send the specific position request message 29. The sequence then follows the above point.

In regard to the “Find a patient” function, this is based on a constant integration between the devices 18 and the server 12. The control center 1 through the localization functionality knows in real-time the position of all devices 18 (ambulances or users 2) on the territory. In the event that there is a need for an ambulance at a certain point (time or location), the control center 1 can send the nearest one or the one that will arrive as soon as possible. The steps in operation are as follows:

1. An ambulance is required in a specific location;

2. The control center 1 through the server application on the server 12 knows the position of all the ambulances/devices 2, 18;

3. The control center 1 via the server application selects the nearest ambulance/device 2, 18 or that which will arrive in the shortest time;

4. Each device 18 is registered on the central server 12 as a record on a database 24;

5. The Server application populates the specific database record (on which the specific device is registered i.e., mailbox 26) with a specific message 29. The message contains:
Device ID 36;
Location to reach as the instructions 33 in the message body 32;
Parity code to prevent transmission errors as the error detection code 34;

6. At regular intervals of one second, each device 18 checks to see if there are any messages on its specific database box 26;

7. If the record is populated by a specific message the device 18 proceeds with the message download;

8. The device software checks the parity code to verify the accuracy of the downloaded message:
If the parity code detects an error, it starts from step 7 until the transmission is correct;
If the parity code detects a non-corrupt downloaded message, it issues a confirmation of successful transmission;

9. The location to be reached is automatically and immediately loaded on a navigator application that starts and manages the automatic navigation to the patient.

In regard to the “Rendezvous” function, the rendezvous is a meeting between two means (i.e., ambulances/users 2) necessary for the exchange of the patient on board. It is used, for example, if the patient is in a non-medical (without medical personnel on board and therefore lacking full potential) and his condition worsens. In this case, if the hospital is too far away, it may be convenient to meet in a middle point the non-medicalized ambulance that carries the patient with a medicalized ambulance that can proceed with the immediate treatment of patient. The steps in operation are as follows:

1. Non medicalized ambulance with patient on board, through dedicated button sends a specific rendezvous request message 39. The message contains:
Sender Device ID 42;
Current Position in the message body 40;
Rendezvous request message in the message body 40;

2. The message 39 is received by the operating central server 12

3. A visual and audible alarm is shown on the server screen of the operative center to catch operator's attention working in the control center 1;

4. The control center 1 through the server application knows the position of all the ambulances/devices 2, 18;

5. The control center 1 via the Web application selects the most suitable and closest medicalized ambulance 2;

6. The choice of the site of the Rendezvous can take place in two ways:
a. Automatic: the server application recommends the place by calculating the minimum arrival time for both ambulances also in relation to possible traffic jam;
b. Manual: the operator choose the meeting place;

7. Each device 18 is registered on the central server 12 as a record on a database;

8. The server application automatically populates the two specific records on which the specific devices relating to the two means of Rendezvous are recorded (i.e., the respective mailboxes 26 of the selected users 2) with a specific message 29 for each. The specific message 29 contains:
a. Rendezvous position to reach in the instructions 33 of the message body 32;
b. Parity code to prevent transmission errors as the error detection code 34;

9. Each device 18, at regular intervals of one second, checks whether there are messages on its specific database record 26;

10. If the record is populated by a specific message 29 the device 18 proceeds with the download of the message;

11. The Device software checks the parity code to verify the accuracy of the downloaded message:
If the parity code detects an error, it starts again from point 9 until transmission is not corrupted;
If the parity code detects the accuracy of the downloaded message, it issues a confirmation;

12. The location to be reached is automatically and immediately loaded on a navigator application of both selected devices 18 that initiate automatic navigation to the place of the Rendezvous.

In regard to the “Health Monitoring System” function, this Health monitoring System allows the device 18 to be connected with sensors to measure the patient's parametric data. The measured data are those related to blood pressure, heart rate, respiratory rate, SpO2, ECG. Sensors equipment can be connected to the device via wired or wireless connection. The measured information is displayed on the Portable Device screen both as an instantaneous data and as a graph that includes the performance of all the instantaneous measurements. The portable device 18 is programmed to set alarm levels. If the measured data is greater than the preset thresholds, the device 18 emits an audible alarm. The measured parametric data are also shared with the operations center that can be examined in real time.

In regard to the “Patient Info” function, this allows an exchange of information about the patient's status through a constant integration between the control center 1 and the device 18 on the territory. The functionality allows three different operations:

1. Download Patient's previous information;

2. Send information from an operating central to a device on the Territory; and

3. Send information from device to operations center.

Operation 1 above allows the portable device 18 to log into the network of the hospital company and to download all the information about the patient. Every specific analysis, specialist examination, hospitalization is saved on Hospital server. Also, each of the measurement managed by the device 18 with the Health monitoring System populates the server store. The operations steps are:

1. Any examination, specific analysis, each carried out measurement with the Health monitoring System will be transferred to populate a database on a Server;

2. The Server is owned by the hospital and is protected by VPN (virtual private network) access and password log in. Only authorized users can access the information database;

3. Each portable device 18 has its own log in credentials. The credentials are automatically loaded at each log in so that you make the operation fast;

4. The operator is searching the patient's general information;

5. Access to the section of the database where's already saved all the previous information about the patient;

6. The information is displayed on the device screen as data on a database table.

Operation 2 above allows an information exchange from the operations control center 1 to the devices 18 in the territory. The normal sequence of operations requires that the patient (or his/her family) call the control center 1 to initiate the service request. The central operator through a telephone interview receives the first information about the patient's general information (name, surname, age, pathological disorder, etc . . .) and where the ambulance 2 is requested. This information is typed on a preformatted table and uploaded to the database record for the specific device 18, which then uses automatic controls to download the information and make it available on the screen. The steps are as follows:

The central operator receives the call from the patient or a family member who initiates the request for assistance;

The operator through a quick telephone interview notes the patient's general information and the location where assistance is required;

The operator through the server application fills out a form with patient data, name, surname, date of birth, pathology presumed, location where the ambulance is required.

The operator selects the ambulance/device 2, 18 to be sent;

The preformatted table is automatically loaded on the database record for the device/Ambulance specification

Each device 18 controls it at one second intervals if there any refresh on the record information;

The device 18 finds the specific preformatted table containing the information you type in the operator on your record;

The Device 18 downloads the preformatted table;

The preformatted table is automatically shown on the Mobile device screen.

Operation 3 above allows an information exchange from the portable device 18 to the operations control center 1. After the arrival of the ambulance 2, generally, a first diagnosis is made then the patient is clinically treated then proceeds with the patient's load for a hospital transport if necessary. Using the Portable device 18, you can fill out a preformatted table containing all the above information, the eventual hospital of destination and a field known for further annotation. This data is sent from the portable device 18 to the operations center 1 that can be displayed using the Server application (on the server 12). In doing so, the control center 1 knows the patient's information prior to hospitalization, and can also share information with the patient's specific target department. The steps are as follows:

The ambulance arrives at destination;

A first clinical diagnosis is made by the onboard doctor;

If necessary, the patient is clinically treated;

If necessary the patient is loaded on the ambulance for a transport to the most suitable hospital structure;

The onboard doctor may fill out a preformatted table containing:
A. The clinical evaluation of the patient who standardizes the severity;
B. The clinical treatment carried out;
C. Pathology;
D. The destination Hospital;

The information is automatically sent from the device 18 to the operating center 1;

The server application shows the central information on the screen;

The central operator can share operations with the specific hospital ward of the patient's destination.

In regard to the “Ambulance State Management” function, from the device 18, using dedicated keys, the user 2 can automatically send information about the state of the ambulance. The possible choices are:

Arrival on site

Patient load

Arrival in First aid

First Aid operation

Arrival at the venue

Arrival at rendezvous-restarting from rendezvous

By activating the specific key, the information of the ambulance state is automatically sent to the operations control center 1. There is a confirmation mechanism chosen to avoid involuntary drives. The information is displayed through the server application on a display and then available at the operations center 1. A display AutoRefresh mechanism is expected as soon as a state changes.

In regard to the “Health Card Compilation” function, the system allows to fill in the preloaded fields that summarize the ambulance intervention. The operation can be done during the intervention or at the end when finished. Using the device 18, the device user 2 can enter all the information he believes is suitable to describe the intervention (example, pathology, time of arrival, any medicines administered, responses to medicines, patient status before and after the administration, etc.). This information is automatically sent to the server application (of server 12) that saves and makes them available at all times. The data, once saved, allows a search by word, by field and by time interval. For example, you can find out how many people are affected by (eg) heart disease during the last year, how many of them have been given a certain drug and the effect that has been administered. The server application through a specially designed software that analyzes the data, automatically provides reports of success or less specific treatments on specific pathologies. The purpose of the functionality is to create a database of medical information that can be studied and used for the evaluation of health operations and for any corrections on them in order to make the process more productive.

In regard to the “Management of On-Board Crew” function, using the portable device 18, you can enter the crew of the ambulance and then type the driver's information about the vehicle, nurse and doctor. The information is automatically sent to the operations center 1 and is displayed by the server application (of server 12) through a screen. A specially designed software automatically ties every intervention to the board crew that performed it.

As soon as the rescue machine is activated the operator of the control server 1 knows the position of all means through the functionality of “localization” and the state of each of the means (whether it is free or if engaged and in what operation). The operator can then send the nearest free ambulance or that which can arrive as soon as possible. Arrival times are minimized by the “Find Patient” or “Rendezvous” features. All information to be exchanged between operations centre and ambulance in place is available through the “Patient info” feature. On-board medical personnel can immediately know the patient's previous information (example: to know if it is a chronic cardiology or to avoid the administration of drugs to which the patient is allergic).

The “Health Monitoring System” feature provides a tool for measuring and sharing the patient's parametric data. The management of the crew allows you to know for every single intervention as the crew to provide it. The “Build Health card” feature instead offers a tool for saving meaningful data of each intervention and measuring and correcting the process to improve all operations.

The scope of the claims should not be limited by the preferred embodiments set forth in the examples but should be given the broadest interpretation consistent with the specification as a whole.

1. A system for communicating between a control center and a plurality of mobile users, comprising:
a server including a memory storing instructions and a processor configured to execute the instructions stored on the memory;
a plurality of portable devices corresponding to the mobile users that are wirelessly communicated with the server;
the memory of the server storing a database which comprises a plurality of mailboxes each associated with a respective one of the portable devices;
the server being configured to post messages to a respective one of the mailboxes for subsequent retrieval by the associated one of the portable devices;
each one of the portable devices being configured for monitoring an associated one of the mailboxes on the database to check for messages which are unread; and
each one of the portable devices being further configured to retrieve a respective one of the messages which are unread upon detection thereof during monitoring the associated one of the mailboxes.

2. The system of claim 1 wherein each one of the portable devices is configured for monitoring by periodic scanning of the associated one of the mailboxes after a prescribed period of time has elapsed since a latest mailbox scan.

3. The system of claim 1 wherein each one of the portable devices is configured to download to a memory thereof the respective one of the messages retrieved from the associated one of the mailboxes.

4. The system of claim 1 wherein the portable devices are registered on the server so as to form the mailboxes stored on the database of the server.

5. The system of claim 1 wherein the server is configured to form the messages each having a message body with instructions for a respective one of the mobile users operating said respective one of the portable devices, and an error detection code which is checked by the respective one of the portable devices upon retrieval of the respective one of the messages to ensure said respective one of the messages has not been corrupted during wireless transmission.

6. The system of claim 5 wherein each one of the portable devices is configured to automatically execute the instructions of the message body on a processor of the respective one of the portable devices if the respective one of the messages is determined not to have been corrupted.

7. The system of claim 6 wherein the instructions comprise directions to a destination location which are loaded by the processor of the respective one of the portable devices onto a navigation application stored on a memory of the respective one of the portable devices.

8. A system for communicating between a control center and a plurality of temporary mobile users, comprising:
a server including a memory storing instructions and a processor configured to execute the instructions stored on the memory;
a plurality of portable devices wirelessly communicated with the server that are temporarily assigned to the mobile users for use thereby such that different ones of the mobile users can use a respective one of the portable devices at different times;
each one of the portable devices being configured to generate a message receivable by the server;
each one of the portable devices being configured to receive as input an identity of an assigned one of the mobile users operating the respective one of the portable devices for a period of time;
each one of the portable devices being configured to incorporate as part of the message a user identifier indicating the identity of the assigned one of the mobile users sending the message to the server.

9. The system of claim 8 wherein the server is configured to form a record of messages sent by the portable devices categorized by the assigned one of the mobile users.

10. The system of claim 8 wherein each one of the portable devices is configured to automatically incorporate the user identifier for each message sent subsequently to a latest input identity of the assigned one of the mobile users.
